(19) United States
(12) Patent Application Publication
(10) Pub. No.: US 2002/0075063 A1
(43) Pub. Date: Jun. 20, 2002

(54) Frequency adaptive negative voltage generator

(75) Inventor: Changku Hwang, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi America, Ltd.

(21) Appl. No.: 09/740,490

(22) Filed: Dec. 18, 2000

(51) Int. Cl. G05F 1/10

(52) U.S. Cl. 327/536

(57) ABSTRACT

A negative voltage generator for an integrated circuit includes a charge pump responsive to the current loading on its output terminal. The charge pump is connected to a comparator which compares the output node of the charge pump with a reference potential. The comparator provides an analog output signal to a variable frequency oscillator, which in turn controls the charge pump. Variations in current loading caused the comparator to make appropriate changes in the oscillation frequency.

### BACKGROUND OF THE INVENTION

This invention relates to CMOS electronic circuits, and in particular to a technique for making such circuits more efficient in conserving power provided to them, and making such circuits easier to design.

Low voltage, high-speed digital CMOS integrated circuits use a low threshold voltage to provide a higher drain current using a lower power supply. Because CMOS transistors have a leakage current, commonly known as sub-threshold current, this approach causes an adverse effect, even when the transistors are in an off-state. For a single inverter the amount of sub-threshold current is essentially negligible. In modern integrated circuits having millions of transistors, however, this effect must be considered because the total leakage current through the entire chip can be substantial. If the effect is ignored, the total sub-threshold current of such an integrated circuit wastes a significant amount of power, leading to shorter battery life, excessive heat, or both.

The sub-threshold current of a transistor formed on an integrated circuit can be reduced by using a suitable back-bias voltage, that is, a potential applied as the substrate voltage of the transistor. By applying the back-bias voltage, the threshold voltage increases (known as the “body effect”), and thus the sub-threshold current decreases. Because this effect may lower the speed of the transistor, the voltage is preferably applied when the circuit is not in its normal operating mode. The normal operating mode is referred to as “active mode” herein. Instead the back-bias potential is usually applied during “stand-by mode,” a mode of operation when the circuit is inactive, for example, because it is awaiting commands from a keyboard, a microprocessor, or some other event. To achieve high-speed operation and low power consumption during active mode, the substrate voltage is controlled so the substrate of an NMOS transistor is tied to ground, while that of a PMOS transistor is tied to the internal power supply, typically V_{DD}. During stand-by mode, the NMOS transistors are connected to a negative voltage, V_{BB}, while the PMOS transistors are connected to a positive voltage, V_{DDQ} higher than V_{DD}. Because the V_{DDQ} is externally provided as a power supply for I/O circuitry, it is necessary to generate the negative voltage, V_{BB}, internally using a negative voltage generator.

FIG. 1 is a conceptual block diagram of a conventional negative voltage generator which uses a fixed-frequency oscillator. Potential Vₒᵤₜ is the voltage to be used for the substrate of an NMOS transistor in stand-by mode.

The circuit of FIG. 1 operates as follows. The comparator compares potential Vₒᵤₜ with potential V_{ref}'. If potential Vₒᵤₜ is higher than the V_{ref}, which is the target voltage to achieve comparator provides a signal, V_{cont}, which turns on the oscillator. The oscillator begins oscillating at a preset frequency f_{osc}, and generates rectangular-shaped pulses with a fixed-frequency. This causes the charge pump to start pumping down potential Vₒᵤₜ. When Vₒᵤₜ reaches V_{ref}, the comparator stops the oscillator operation until the current load increases, causing potential Vₒᵤₜ to again become higher than potential V_{ref}.

FIG. 2 illustrates these signals, showing the waveform at each node. If the oscillation frequency, f_{osc} is high (see FIG. 2b), the duty cycle of pulses V_{cont} is shorter. On the other hand, if the oscillation frequency is lower (see FIG. 2a), the duty cycle is longer. In this type of generator, the frequency f_{osc} is ‘fixed’ at the time of fabrication or thereafter. This frequency determines the performance of the voltage generator, including its pump-down speed, the ripple magnitude at the Vₒᵤₜ terminal, its maximum load-handling capability, etc.

FIG. 3 illustrates two disadvantages of the circuit of FIG. 1. When f_{osc} is too low and the load is high (FIG. 3a), potential Vₒᵤₜ never reaches potential V_{ref}. But, if f_{osc} is high and the generator responds too slowly, potential Vₒᵤₜ fluctuates widely, creating undesirable large ripples in the output signal. Therefore, it is very important to determine the appropriate operating frequency and maintain it over the wide range of variations in process technology. Of course this is not easy to do, and requires frequent adjustment of the circuitry as one deigns successor products, where it would otherwise be desirable to maintain a constant design.

### SUMMARY OF THE INVENTION

This invention provides a new frequency-adaptive negative voltage generator. The negative voltage generator uses a voltage controlled oscillator rather than fixed frequency oscillator. This allows the operating frequency of the new frequency-adaptive negative voltage generator to vary and be determined by load conditions. A substantial benefit of the circuit is its process insensitive circuit design. It handles a wide range of output loads and pumps-down quickly.

In a preferred embodiment, a negative voltage generator according to the invention includes a charge pump connected to provide a negative potential to an output node, the output node having a current load. The charge pump produces a negative potential which varies based on an input signal supplied to it. A controller circuit is connected to the output node, and also connected to receive a reference potential for producing a control signal in response to a comparison of the reference potential and the potential of the output node. The controller is connected to control a variable frequency oscillator, which in response provides an input signal to the charge pump. The arrangement allows the capability of the pump to vary depending upon the load.

### BRIEF DESCRIPTION OF THE DRAWINGS

FIG. 1 is a blocked diagram of a prior art negative voltage generator using a fixed frequency oscillator.

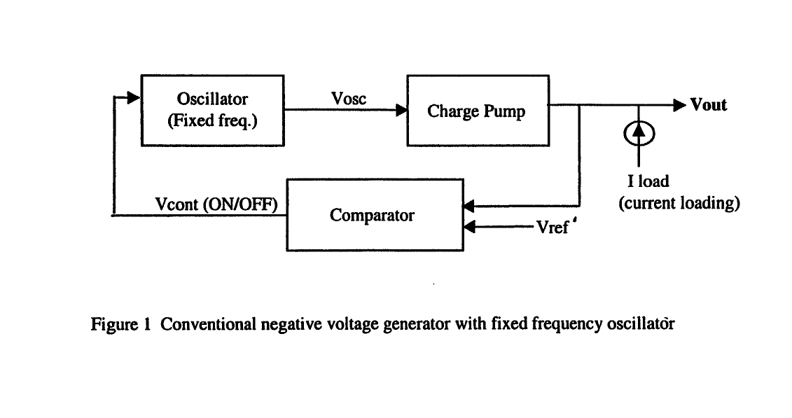

FIG. 2 are timing diagrams illustrating the operation of the prior art negative voltage generator.

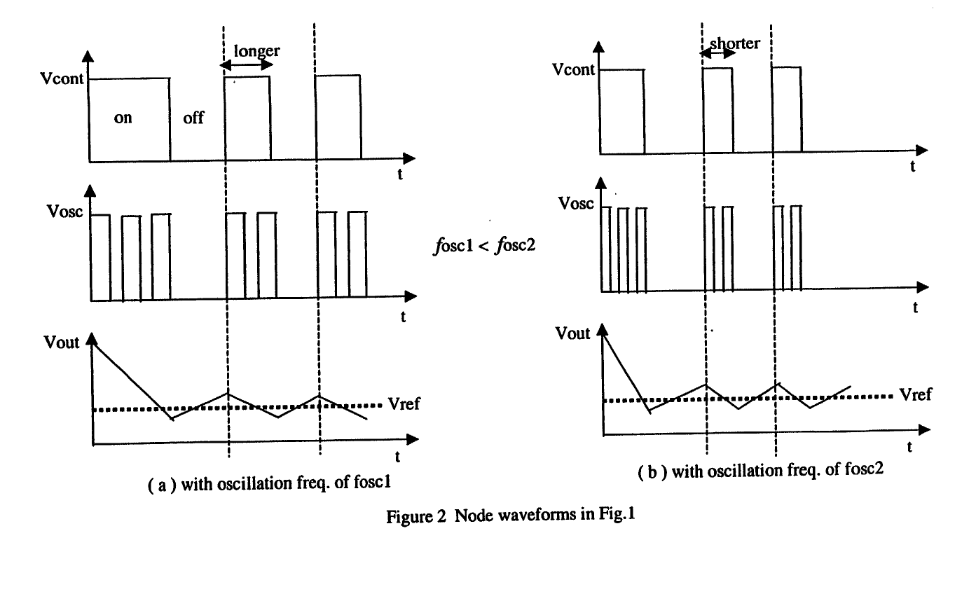

FIG. 3 are additional wave forms illustrating disadvantages of the prior art negative voltage generator.

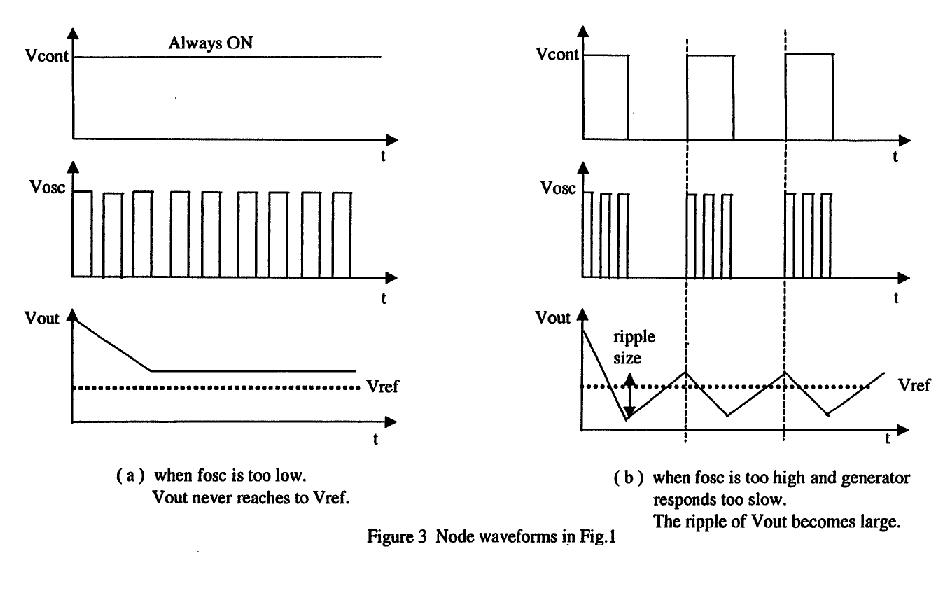

FIG. 4 is a block diagram illustrating a preferred embodiment of the new negative voltage generator.

FIG. 5 are timing diagrams illustrating benefits of the preferred embodiment.

FIG. 6 is a schematic diagram illustrating a preferred embodiment of the controller circuit for controlling the oscillator.

### DESCRIPTION OF THE SPECIFIC EMBODIMENTS

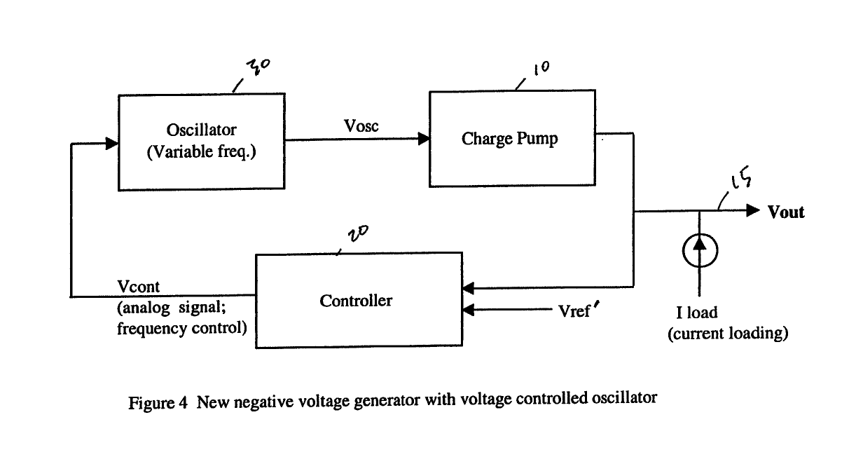

FIG. 4 is a block diagram of a preferred embodiment of a negative voltage generator according to this invention. As shown in FIG. 4, a charge pump 10 supplies a negative output voltage Vₒᵤₜ to node 15. Node 15 is coupled to the remainder of the integrated circuit upon which the negative voltage generator is fabricated. This integrated circuit “loads” the voltage generator with a current load coupled to node 15.

Node 15 is also connected to controller 20, together with potential V_{ref}'. Controller 20 compares Vₒᵤₜ and V_{ref}' and in response generates a control signal V_{cont}. V_{cont} is an analog signal which controls the frequency of oscillator 30. In other words, the analog signal from controller 20 will vary, and as it varies, the frequency supplied by oscillator 30 will vary correspondingly. The variable output frequency from oscillator 30, V_{osc}, is in turn provided to control charge pump 10.

Unlike the conventional fixed-frequency voltage generator described above, the generator of the preferred embodiment (FIG. 4) uses a voltage controlled oscillator (VCO). As the controller 20 compares Vₒᵤₜ with V_{ref}', assuming that potential Vₒᵤₜ is higher than potential V_{ref}, the controller increases the magnitude of the control signal, V_{cont}. This increases the oscillating frequency of the oscillator 30. The pumping capability of the charge pump 10, in turn, increases and thus potential Vₒᵤₜ decreases. (Vₒᵤₜ is a negative voltage.) This pumping process continues until the potential Vₒᵤₜ reaches V_{ref}. Once Vₒᵤₜ equals V_{ref}, the output of the controller, V_{cont}, remains unchanged.

On the other hand, if potential Vₒᵤₜ is lower than potential V_{ref}, the controller reduces V_{cont} to lower the pumping capability of the charge pump. This process also continues until potential Vₒᵤₜ increases and reaches V_{ref}. In this way, the oscillating frequency of the oscillator adaptively changes and attempts to settle on a steady state condition where its value which makes Vₒᵤₜ equal to V_{ref}. Of course, as operations performed by the integrated circuit upon which the voltage generator is formed change, the current loading I_{load} will change, causing the frequency to change as well. The final oscillating frequency will be determined according to the current load at the output of the charge pump 10.

For example, if the pump output experiences a heavy load (high current loading), the oscillating frequency becomes higher. The opposite circumstance sets the oscillator at a low frequency. An advantage of using this method is that, because the oscillating frequency is primarily determined by the load condition, not by transistor sizes, this method is very insensitive to variations in process conditions.

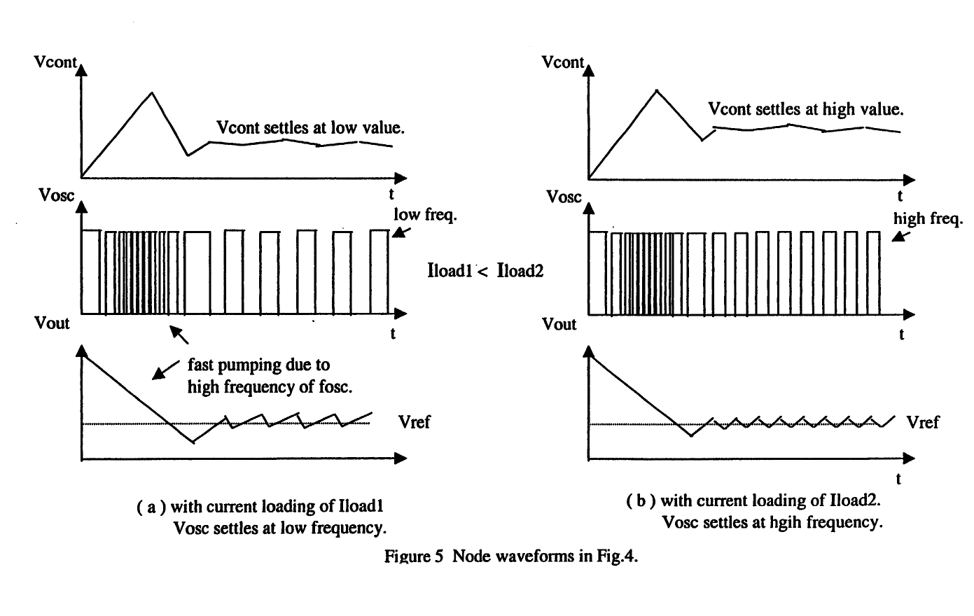

FIGS. 5a and 5b are timing diagrams illustrating waveforms of the circuit under different operating conditions. FIG. 5a shows a circumstance in which a relatively low current loading is imposed on node 15. As a result of this, the analog control signal V_{cont} will pump quickly at first, and then more slowly later. For example, in the lower portion of FIG. 5a, note that Vₒᵤₜ is initially well above V_{ref}, resulting in numerous cycles of V_{osc} to reduce Vₒᵤₜ to the level of V_{ref}. Then, as the current loading continues, Vₒᵤₜ will creep back above V_{ref}, triggering the controller and turning on the oscillator to again pump the potential lower.

FIG. 5b is a timing diagram illustrating what happens if the higher current loading is applied to the node 15. In this case, the same initial fast pumping action is necessary to bring Vₒᵤₜ down to V_{ref}. Once it reaches V_{ref}, however, the higher current loading will turn on the controller more frequently. This will result in an increased number of V_{osc} pulses, and a faster changing of state with respect to V_{ref} of signal Vₒᵤₜ.

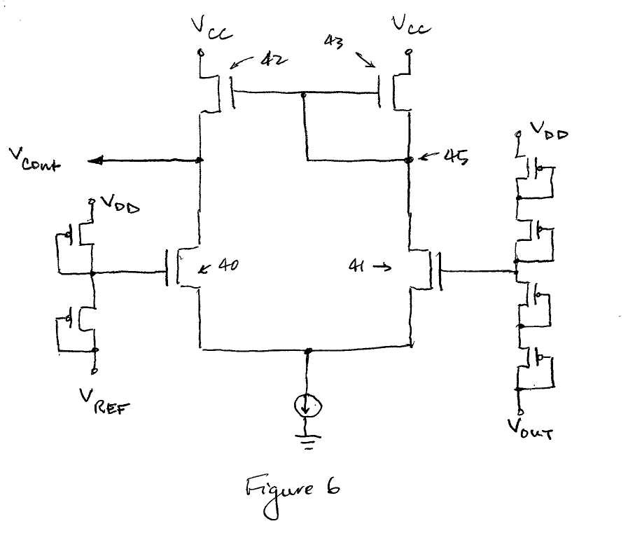

The detailed circuitry for implementation of charge pump 10 and oscillator 30 are well known, and can be selected from conventionally available circuits. FIG. 6 illustrates an elegant implementation of a control circuit 20 for use in conjunction with conventional charge pumps and oscillators. As shown in FIG. 6, parallel connected NMOS transistors 40 and 41 receive signals from Vₒᵤₜ and V_{ref}'. The Vₒᵤₜ input is coupled to charge pump 10, while the V_{ref}' input is provided by a fixed potential source. NMOS transistors 42 and 43 have commonly coupled gates to node 45. As Vₒᵤₜ varies based on the current loading of node 15, V_{cont} will be turned on to a greater or lesser extent, and can be used for controlling oscillator 30.

The preceding has been a description of a preferred embodiment of the negative voltage generator of this invention. It provides significant advantages over prior art negative voltage generators. In particular, because prior art generators create a sawtooth wave as the comparisons go on and off between the reference signal and the output node, the generator must be carefully designed to tolerate the maximum range of input loading over the full range of possible variations and circuit characteristics. This is quite difficult when one must also consider varying process tolerances. Because the oscillator frequency must be set in advance, if the current loading is too high the oscillator is not able to keep up. Furthermore, because of the necessity of matching the negative voltage generator to the characteristics of the integrated circuit chip, the design is not portable to other generations of corresponding products. The use of variable frequency oscillator according to this invention allows the voltage generator to match the demands of the current loading, thereby reducing the size of ripples, consuming power only when necessary, and making the design portable across multiple generations of integrated circuits.

The preceding has been a description of the preferred embodiment of the invention. It will be appreciated that deviations and modifications can be made without departing from the scope of the invention, which is defined by the appended claims. For example, although a negative voltage generator has been described herein, those of ordinary skill will appreciate that the concepts described are equally applicable to a positive voltage generator.

What is claimed is:

1. A negative voltage generator comprising:
a charge pump connected to provide a potential to an output node, the output node having a current load, the charge pump for producing a negative potential which varies based on an input signal thereto;
a controller circuit connected to the output node having a potential, and connected to receive a reference potential, for producing a control signal in response to a comparison of the reference potential and the potential of the output node; and
a variable frequency oscillator connected to receive the control signal and in response provide the input signal to the charge pump.

2. A negative voltage generator as in claim 1 wherein the control signal is an analog signal.

3. A negative voltage generator as in claim 2 wherein the reference potential is a fixed potential.

4. A negative voltage generator as in claim 3 wherein the controller circuit comprises first and second serially connected transistors and third and fourth serially connected transistors, the first transistor having a gate connected to the output node and a drain connected to a common node, the second transistor having a gate connected to the reference potential and a drain connected to the common node.

5. A negative voltage generator as in claim 4 wherein the third and fourth transistors have sources coupled to a potential supply, and wherein the commonly coupled gates are connected to a source of the second transistor.

6. A negative voltage generator as in claim 5 wherein the control signal is provided at a node of the controller circuit connected to the source of the first transistor.

7. A negative voltage generator for generating an output potential at an output node of a charge pump circuit comprising a variable frequency oscillator connected to provide an input signal to the charge pump.

8. A voltage generator comprising:
a charge pump connected to provide a potential to an output node, the output node having a current load, the charge pump for producing a potential which varies based on an input signal thereto;
a controller circuit connected to the output node having a potential, and connected to receive a reference potential, for producing a control signal in response to a comparison of the reference potential and the potential of the output node; and
a variable frequency oscillator connected to receive the control signal and in response provide the input signal to the charge pump.

9. A voltage generator as in claim 8 wherein the control signal is an analog signal.

10. A voltage generator as in claim 9 wherein the reference potential is a fixed potential.

11. A voltage generator for generating an output potential at an output node of a charge pump circuit comprising a variable frequency oscillator connected to provide an input signal to the charge pump.
